(19) United States
(12) Patent Application Publication
(10) Pub. No.: US 2005/0164695 A1
(43) Pub. Date: Jul. 28, 2005

(54) Method and system for managing wireless network information collection utilizing a telematics unit

(75) Inventors: Hitan S. Kamdar, Utica, MI (US); Russell A. Patenaude, Macomb Township, MI (US); Anthony J. Sumcad, Southfield, MI (US); Shpetim S. Veliu, Livonia, MI (US); Brad T. Reeser, Lake Orion, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/767,237

(22) Filed: Jan. 28, 2004

(51) Int. Cl. H04M 3/00

(52) U.S. Cl. 455/420; 455/41.2

(57) ABSTRACT

The present invention provides a method for managing wireless network information collection utilizing a telematics unit within a telematics equipped mobile vehicle. The method includes detecting at least one wireless short-distance communication network identification signal, generating wireless network information based on the detected wireless network identification signals, and communicating the generated wireless network information to a service provider. The wireless short-distance communication network identification signal may include an internet protocol address, a location identification tag, GPS coordinates, points of interest, venue capacity, venue size, or category. The step of detecting the wireless short-distance communication network identification signal includes receiving at least one wireless short-distance communication network identification signal, determining a unique device identifier associated with each received wireless short-distance communication network identification signal, and storing the determined unique device identifier.

### FIELD OF THE INVENTION

This invention relates generally to wireless communications with a mobile vehicle. More specifically, the invention relates to a method and system for managing wireless network information collection utilizing a telematics unit within a telematics equipped mobile vehicle.

### BACKGROUND OF THE INVENTION

The opportunity to utilize wireless features in a mobile vehicle is ever increasing as the automobile is being transformed into a communications and entertainment platform as well as a transportation platform. Wireless features include wireless vehicle communication, networking, maintenance and diagnostic services for a mobile vehicle.

Typically, conventional wireless systems within mobile vehicles (e.g. telematics units) provide voice communication. Recently, these wireless systems have been utilized to update systems within telematics units, such as, for example radio station presets. Similar to other conventional wireless systems, telematics units within mobile vehicles are required to regularly register with the mobile vehicle communication system (MVCS). This registration is called a registration request. The registration request notifies the MVCS that the telematics unit is operational and is operating within a specified portion of the MVCS.

Additionally, networking within the MVCS utilizing short-distance communication protocols has become available and an increasing useful part of the telematics package.

The present invention advances the state of the art.

### SUMMARY OF THE INVENTION

One aspect of the invention includes a method for wireless network data collection utilizing a telematics unit within a mobile vehicle communication system. The method includes detecting at least one wireless short-distance communication network identification signal, generating wireless network information based on the at least one detected wireless network identification signals, and communicating the generated wireless network information to a service provider.

In accordance with another aspect of the invention, a computer readable medium storing a computer program includes: computer readable code for detecting at least one wireless short-distance communication network identification signal; computer readable code for generating wireless network information based on the at least one detected wireless network identification signals; and computer readable code for communicating the generated wireless network information to a service provider.

In accordance with yet another aspect of the invention, a system for operating a telematics unit within a mobile vehicle is provided. The system includes means for detecting at least one wireless short-distance communication network identification signal. Means for generating wireless network information based on the at least one detected wireless network identification signals is provided. Means for communicating the generated wireless network information to a service provider is also provided.

The aforementioned, and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates an operating environment for implementing wireless communication within a mobile vehicle communication system;

FIG. 2 is a block diagram of telematics based system in accordance with an embodiment of the present invention; and

FIG. 3 is a flow diagram of one embodiment of a method of managing wireless network information collection utilizing a telematics unit, in accordance with the present invention.

### DETAILED DESCRIPTION OF THE DRAWINGS

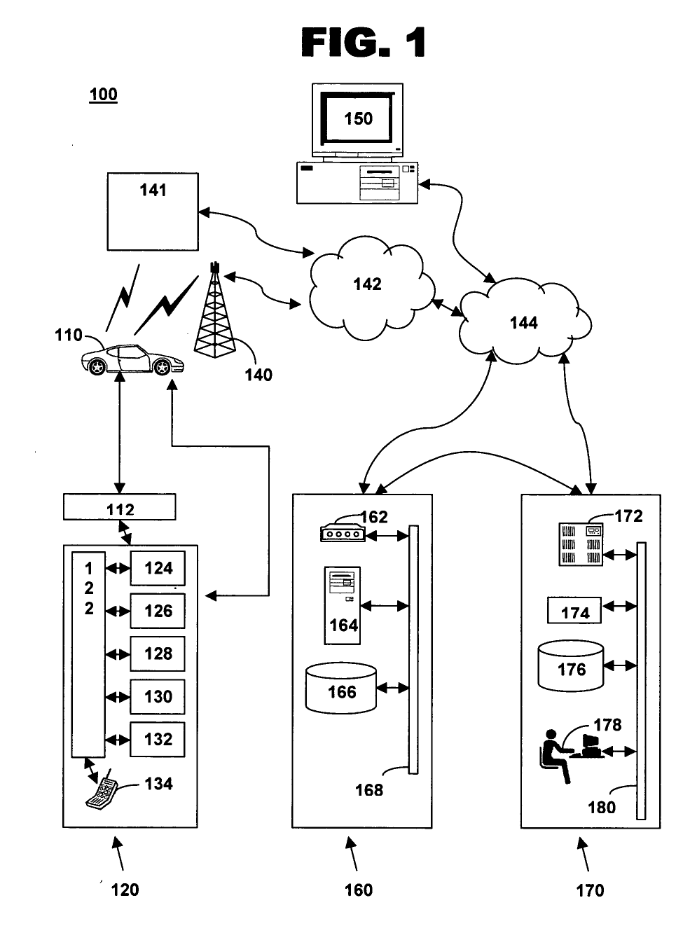

FIG. 1 illustrates one embodiment of system for data transmission over a wireless communication system, in accordance with the present invention at 100. Mobile vehicle communication system (MVCS) 100 includes a mobile vehicle communication unit (MVCU) 110, a vehicle communication network 1 12, a telematics unit 120, one or more wireless carrier systems 140, one or more short-distance communication systems 141, one or more communication networks 142, one or more land networks 144, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 may also be referred to as a mobile vehicle throughout the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications. Communication network 112 is also referred to as a communication bus.

MVCU 110, via telematics unit 120, sends to and receives radio transmissions from wireless carrier system 140. Wireless carrier system 140 is implemented as any suitable system for transmitting a signal from MVCU 110 to communication network 142.

Telematics unit 120 includes a digital signal processor (DSP) 122 connected to a wireless modem 124, a global positioning system (GPS) unit 126, an in-vehicle memory 128, a microphone 130, one or more speakers 132, short-distance communication module 134, and an embedded or in-vehicle mobile phone 134. In other embodiments, telematics unit 120 may be implemented without one or more of the above listed components, such as, for example speakers 132. Telematics unit 120 may include additional components not relevant to the present discussion.

In one embodiment, DSP 122 is implemented as a microcontroller, controller, host processor, or vehicle communications processor. In an example, DSP 122 is implemented as an application specific integrated circuit (ASIC). In another embodiment, DSP 122 is implemented as a processor working in conjunction with a central processing unit (CPU) performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone, such as, for example an analog, digital, dual-mode, dual-band, multi-mode or multi-band cellular phone.

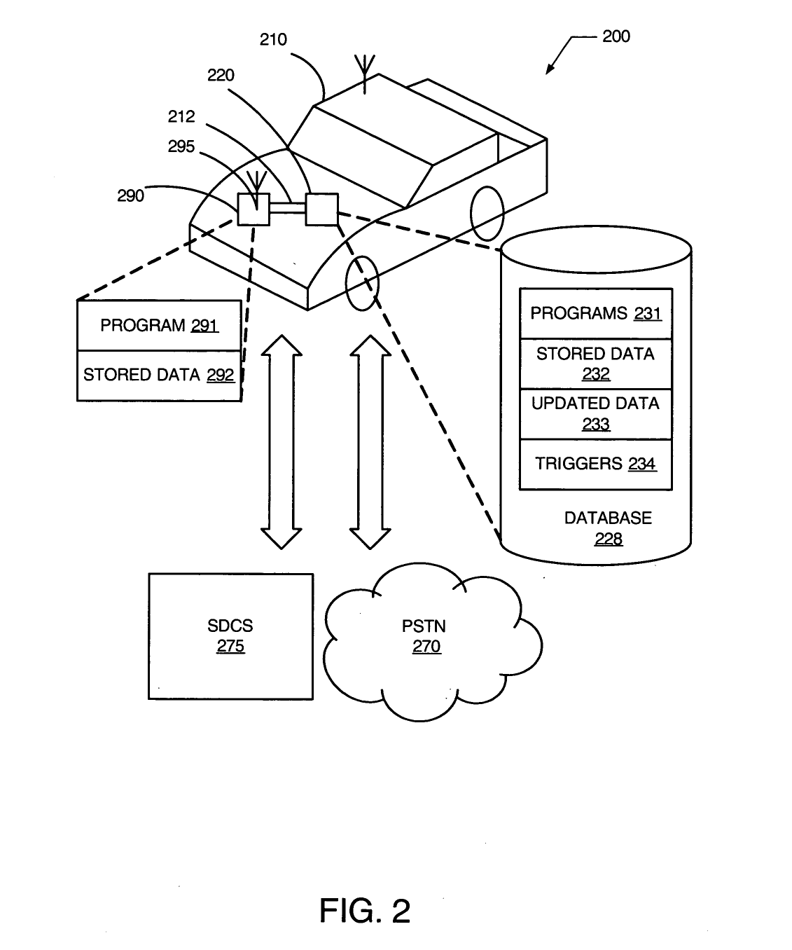

Wireless modem 124 includes hardware and software for sending and receiving (detailed in FIG. 2 below) short-distance communications to and from short-distance communication system 141. Examples of short-distance communications include a radio frequency identification data (RFID), short message service signal, an IEEE 802.11 standard compliant signal, or a Bluetooth compliant signal. In one embodiment and illustrated in FIG. 1, wireless modem 124 is located separate from DSP 122. In another embodiment, wireless modem 124 is located within DSP 122. Short-distance communication system 141 is implemented as any suitable system for transmitting a signal, such as described above, from MVCU 110 to communication network 142. In one embodiment, short-distance communication system 141 is a wireless fidelity, called a “wi-fi”, network located within a business, such as, for example a coffee shop, a café, and the like.

DSP 122 executes various computer programs that affect programming and operational modes of electronic and mechanical systems within MVCU 110. DSP 122 controls communications (e.g. call signals) between telematics unit 120, wireless carrier system 140, and call center 170 as well as communications (e.g. call signals) between telematics unit 120, short-distance communication system 141 via wireless modem 124, and call center 170. In one embodiment, a voice-recognition application is installed in DSP 122 that can translate human voice input through microphone 130 to digital signals. DSP 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from DSP 122 are translated into voice messages and sent out through speaker 132.

Communication network 142 includes services from one or more mobile telephone switching offices and wireless networks. Communication network 142 connects wireless carrier system 140 and short-distance communication system 141 to land network 144. Communication network 142 is implemented as any suitable system or collection of systems for connecting wireless carrier system 140 and short-distance communication system 141 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 and short-distance communication system 141 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110.

In operation, a client utilizes computer 150 to initiate setting or re-setting of user-preferences for MVCU 110. In an example, a client utilizes computer 150 to provide radio station presets as user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as, for example, door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to telematics unit 120 within mobile vehicle 110 from call center 170. In one embodiment, the call is routed to telematics unit 120 from call center 170 via land network 144, communication network 142, and wireless carrier system 140.

FIG. 2 is a block diagram of a telematics based system in accordance with an embodiment of the present invention. FIG. 2 shows a telematics based system 200 for managing wireless network information collection utilizing a telematics unit within a telematics equipped mobile vehicle.

In FIG. 2, the system includes a mobile vehicle 210 having a telematics unit 220 coupled to one or more vehicle system modules 290 via a vehicle communication bus 212, a communication network 270, such as, for example a public switched telephone network (PSTN), and a short-distance communication system (SDCS) 275. Telematics unit 220 further includes a database 228 that contains programs 231, stored data 232, updated data 233 and triggers 234. Vehicle system module (VSM) 290 further includes a program 291 stored data 292, and short-distance communication antenna 295. In one embodiment, VSM 290 is located within telematics unit 220. In FIG. 2, the elements are presented for illustrative purposes and are not intended to be limiting. Telematics based system 200 may include additional components not relevant to the present discussion.

Telematics unit 220 is any telematics device enabled for operation with a telematics service provider, such as, for example telematics unit 120 as described with reference to FIG. 1. Telematics unit 220 in vehicle 210 is in communication with communication network 270 (e.g. a “PSTN”). Telematics unit 220 includes volatile and non-volatile memory components for storing data and programs. In one embodiment, memory components in telematics unit 220 contain database 228.

Database 228 includes one or more programs 231 for operating telematics unit 220, such as, for managing wireless network information collection utilizing a telematics unit. In operation, program 231 detects at least one wireless short-distance communication network identification signal from short-distance communication system (SDCS) 275 at updated data 233 utilizing a vehicle system module (VSM), such as, for example a wireless modem (described below). Program 231 generates wireless network information based on the at least one detected wireless network identification signals and communicates the generated wireless network information to a service provider via PSTN 270. Examples of wireless short-distance communication network identification signals include a short message service signal, an IEEE 802.11 standard compliant signal, or a Bluetooth compliant signal.

In one embodiment, detecting at least one wireless short-distance communication network identification signal includes receiving at least one wireless short-distance communication network identification signal from a vehicle system module, determining a unique device identifier associated with each received wireless short-distance communication network identification signal, and storing the determined unique device identifier. In an example, detecting at least one wireless short-distance communication network identification signal includes receiving at least one wireless short-distance communication network identification signal from vehicle system module 290 and caching the network identification signal at updated data 233, determining a unique device identifier associated with each received wireless short-distance communication network identification signal utilizing program 231, and storing the determined unique device identifier at stored data 232. Examples of wireless network information included within the short-distance communication network identification signal are an internet protocol address, an identification tag, location information, such as, GPS coordinates, points of interest, venue capacity, venue size, and category (i.e. restaurant, theater, etc.).

In another embodiment, generating wireless network information based on the at least one detected wireless network identification signals includes associating a GPS coordinate with the detected wireless short-distance communication network identification signal and storing the wireless short-distance communication network identification signal and the associated GPS coordinate. In an example, the GPS coordinate is based on the location of the telematics unit at the time of reception. In another example, the GPS coordinate is included within the at least one wireless short-distance communication network identification signal.

In yet another embodiment, communicating the generated wireless network information to a service provider includes detecting a wireless network information upload trigger and initiating a wireless network information transmission to the service provider responsive to the detected wireless network information upload trigger. In an example, the information upload trigger is included within a signal received at telematics unit 220 from a service provider via PSTN 270. In another example, the information upload trigger is stored at triggers 234. In another embodiment, communicating the generated wireless network information to a service provider further includes transmitting the wireless network information to a service provider. In an example, detecting a wireless network information upload trigger includes receiving a wireless network information request and processing the wireless network information request to identify the wireless network information upload trigger.

Vehicle system module (VSM) 290 is any vehicle system control module having software and hardware components for operating, controlling or monitoring one or more vehicle systems. In one embodiment, VSM 290 is a wireless modem, such as, for example wireless modem 124 as illustrated in FIG. 1, above. In another embodiment, VSM 290 is a global positioning system (GPS) module, such as, for example GPS unit 126 of FIG. 1. In yet another embodiment, VSM 290 is a controller for controlling a vehicle system such as, for example, a powertrain control module for controlling and monitoring powertrain functions.

Vehicle system module 290 contains one or more processors, one or more memory devices and one or more connection ports. In one embodiment, VSM 290 includes a software switch for scanning received information, such as, for example sensor information to identify that data has been received. VSM 290 is coupled to a vehicle communication bus 212, and therefore to any other device that is also coupled to vehicle communication bus 212. The vehicle communication bus is also referred to as a vehicle communication network. In one embodiment, VSM 290 is directly coupled to telematics unit 220, such as, for example vehicle communication bus 212 coupling telematics unit 220 to vehicle system modules 290. In an example, vehicle communication bus 212 is a vehicle communication network 112 as described in FIG. 1, above. In another embodiment, VSM 290 is indirectly coupled to telematics unit 220. In yet another embodiment, VSM 290 is coupled to short-distance communication antenna 295.

VSM 290 includes one or more programs 291 and stored data 292 stored in memory. In one embodiment, program 291 includes software for detecting at least one wireless short-distance communication network identification signal via short-distance communication antenna 295. In an example, detecting at least one wireless short-distance communication network identification signal includes receiving at least one wireless short-distance communication network identification signal and storing the received wireless short-distance communication network identification signal prior to sending the received wireless short-distance communication network identification signal to telematics unit 220 for processing, such as, for example to generate wireless network information to be communicated to a service provider.

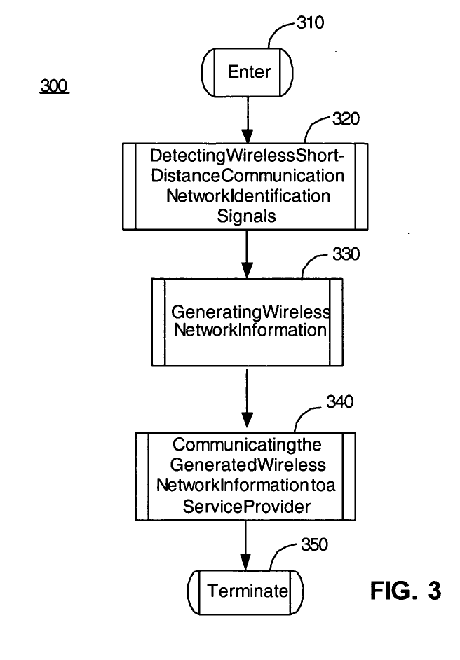

FIG. 3 is a flow diagram of an embodiment of a method of managing wireless network information collection utilizing a telematics unit within a telematics equipped mobile vehicle. In FIG. 3, method 300 may utilize one or more systems detailed in FIGS. 1 and 2, above. The present invention can also take the form of a computer usable medium including a program for configuring an electronic module within a vehicle. The program stored in the computer usable medium includes computer program code for executing the method steps described in FIG. 3. In FIG. 3, method 300 begins at step 310.

At step 320, at least one wireless short-distance communication network identification signal is detected. In one embodiment, detecting the at least one wireless short-distance communication network identification signal includes receiving at least one wireless short-distance communication network identification signal, determining a unique device identifier associated with each received wireless short-distance communication network identification signal, and storing the determined unique device identifier. Examples of a short-distance communication network identification signal include a short message service signal, an IEEE 802.11 standard compliant signal, and a Bluetooth compliant signal. The short-distance communication network identification signal includes information, such as, for example an internet protocol address, an identification tag, GPS coordinates, points of interest, venue capacity, venue size, and category (i.e. restaurant, theater, etc.). In an example, the determined unique device identifier includes one or more of the aforementioned items.

At step 330, wireless network information is generated based on the at least one detected wireless network identification signals. In one embodiment, generating wireless network information based on the at least one detected wireless network identification signals includes associating a GPS coordinate with the detected wireless short-distance communication network identification signal and storing the wireless short-distance communication network identification signal and the associated GPS coordinate. In an example, the GPS coordinate is based on the location of the telematics unit at the time of reception. In another example, the GPS coordinate is included within the at least one wireless short-distance communication network identification signal.

At step 340, the generated wireless network information is communicated to a service provider. In one embodiment, communicating the generated wireless network information to a service provider includes detecting a wireless network information upload trigger and initiating a wireless network information transmission to the service provider responsive to the detected wireless network information upload trigger. In an example, the information upload trigger is included within a signal received at the telematics unit from a service provider. In another example, the information upload trigger is stored within the telematics unit.

In another embodiment, communicating the generated wireless network information to a service provider further includes transmitting the wireless network information to a service provider. In an example, detecting the wireless network information upload trigger includes receiving a wireless network information request and processing the wireless network information request to identify the wireless network information upload trigger.

At step 350, the method is terminated.

The above-described methods and implementation for managing wireless network information collection utilizing a telematics unit within a telematics equipped mobile vehicle are example methods and implementations. These methods and implementations illustrate one possible approach for managing wireless network information collection utilizing a telematics unit within a telematics equipped mobile vehicle. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its spirit or essential characteristics. The described embodiments are to be considered in all respects only as illustrative and not restrictive.

1. A method for wireless network data collection utilizing a telematics unit within a mobile vehicle communication system, the method comprising:
detecting at least one wireless short-distance communication network identification signal;
generating wireless network information based on the at least one detected wireless network identification signals; and
communicating the generated wireless network information to a service provider.

2. The method of claim 1, wherein detecting the at least one wireless short-distance communication network identification signal comprises:
receiving at least one wireless short-distance communication network identification signal;
determining a unique device identifier associated with each received wireless short-distance communication network identification signal; and
storing the determined unique device identifier.

3. The method of claim 1, wherein the wireless short-distance communication network identification signal includes information selected from the group consisting of: an internet protocol address, GPS location, a location identification tag, points of interest, venue capacity, venue size, and category.

4. The method of claim 1, wherein generating the wireless network information comprises:
associating a GPS coordinate with the detected wireless short-distance communication network identification signal; and
storing the wireless short-distance communication network identification signal and the associated GPS coordinate.

5. The method of claim 4, wherein the GPS coordinate is based on the location of the telematics unit at the time of reception.

6. The method of claim 4, wherein the GPS coordinate is included within the at least one wireless short-distance communication network identification signal.

7. The method of claim 1, wherein the at least one wireless short-distance communication network identification signal is selected from the group consisting of: radio frequency identification data, a short message service signal, an IEEE 802.11 standard compliant signal, and a Bluetooth compliant signal.

8. The method of claim 1, wherein communicating the generated wireless network information to a service provider comprises:
detecting a wireless network information upload trigger; and
initiating a wireless network information transmission to the service provider responsive to the detected wireless network information upload trigger.

9. The method of claim 8, wherein detecting the wireless network information upload trigger comprises:
receiving a wireless network information request; and
processing the wireless network information request to identify the wireless network information upload trigger.

10. The method of claim 8, further comprising:
transmitting the wireless network information to a service provider.

11. A computer readable medium for operating a telematics unit within a mobile vehicle, comprising:
computer readable code for detecting at least one wireless short- distance communication network identification signal;
computer readable code for generating wireless network information based on the at least one detected wireless network identification signals; and
computer readable code for communicating the generated wireless network information to a service provider.

12. The computer readable medium of claim 11, wherein the computer readable code for detecting at least one wireless short-distance communication network identification signal comprises:
computer readable code for processing the received at least one wireless short-distance communication network identification signal;
computer readable code for determining a unique device identifier associated with each received wireless short-distance communication network identification signal; and
computer readable code for storing the determined unique device identifier.

13. The computer readable medium of claim 11, wherein the computer readable code for generating wireless network information based on the at least one detected wireless network identification signals comprises:
computer readable code for associating a GPS coordinate with the detected wireless short-distance communication network identification signal; and
computer readable code for storing the wireless short-distance communication network identification signal and the associated GPS coordinate.

14. The computer readable medium of claim 11, wherein the GPS coordinate is based on the location of the telematics unit at the time of reception.

15. The computer readable medium of claim 11, wherein the GPS coordinate is included within the at least one wireless short-distance communication network identification signal.

16. The computer readable medium of claim 11, wherein the at least one wireless short-distance communication network identification signal is selected from the group consisting of: radio frequency identification data ,a short message service signal, an IEEE 802.11 standard compliant signal, and a Bluetooth compliant signal.

17. The computer readable medium of claim 11, wherein the computer readable code for communicating the generated wireless network information to a service provider comprises:
computer readable code for detecting a wireless network information upload trigger; and
computer readable code for initiating a wireless network information transmission to the service provider responsive to the detected wireless network information upload trigger.

18. The computer readable medium of claim 11, wherein the computer readable code for detecting the wireless network information upload trigger comprises:
computer readable code for processing a received wireless network information request to identify the wireless network information upload trigger.

19. The computer readable medium of claim 11, further comprising:
computer readable code for transmitting the wireless network information to a service provider.

20. A system for operating a telematics unit within a mobile vehicle, the system comprising:
means for detecting at least one wireless short-distance communication network identification signal;
means for generating wireless network information based on the at least one detected wireless network identification signals; and
means for communicating the generated wireless network information to a service provider.
